(19) United States
(12) Patent Application Publication
(10) Pub. No.: US 2023/0192534 A1
(43) Pub. Date: Jun. 22, 2023

(54) CRYSTALLIZED GLASS

(71) Applicant: AGC Inc., Tokyo (JP)

(72) Inventors: Shigeki SAWAMURA, Tokyo (JP); Eriko MAEDA, Tokyo (JP); Shusaku AKIBA, Tokyo (JP); Satoshi OGAMI, Tokyo (JP)

(73) Assignee: AGC Inc., Tokyo (JP)

(21) Appl. No.: 18/109,851

(22) Filed: Feb. 14, 2023

Related U.S. Application Data
(63) Continuation of application No. PCT/JP2021/027043, filed on Jul. 19, 2021.

(30) Foreign Application Priority Data
Aug. 21, 2020 (JP) 2020-140348

(51) Int. Cl. C03C 10/00

(52) U.S. Cl. CPC C03C 10/0027

(57) ABSTRACT

The present invention relates to a glass ceramic having a lithium aluminosilicate composition and including a crystal and a residual glass, in which the residual glass has a composition including, in terms of mol % based on oxides: 25% to 70% of SiO₂; 3% to 35% of Al₂O₃; 0.1% to 20% of Li₂O; 0.1% to 20% of Na₂O; 0% to 10% of K₂O; and 1% to 15% of ZrO₂, and a parameter V is −600 or more and 720 or less, the parameter V being calculated based on the following formula: V=49.589×[SiO₂]+61.806×[Al₂O₃]+45.456×[P₂O₅]+41.151×[MgO]+110.26×[CaO]+50.263×[SrO]+55.693×[Li₂O]+3.598×[Na₂O]+9.503×[K₂O]+6.83×[TiO₂]−2.885×[ZrO₂]−3746.99.

### CROSS-REFERENCE TO RELATED APPLICATIONS

This is a bypass continuation of International Patent Application No. PCT/JP2021/027043, filed on Jul. 19, 2021, which claims priority to Japanese Patent Application No. 2020-140348, filed on Aug. 21, 2020. The contents of these applications are hereby incorporated by reference in their entireties.

### TECHNICAL FIELD

The present invention relates to glass ceramics having excellent properties of disappearance and reprecipitation of crystals during remelting.

### BACKGROUND ART

A chemically strengthened glass that is thin and has high strength is used as a cover glass of a mobile phone, a smartphone, or the like. As a glass for chemical strengthening, glass ceramics may be used because the glass ceramics are transparent and hardly damaged.

The glass ceramics are obtained by heat-treating an amorphous glass (base glass) to precipitate crystals therein, and contains precipitated crystals and a residual glass. Various compositions are known as glass ceramics. Among them, glass ceramics in which lithium aluminosilicate (LAS) crystals are precipitated can obtain very high strength by chemical strengthening treatment (for example, Patent Literature 1).

A general production process of the glass ceramics sequentially includes a step of blending materials, a melting step, a forming step, a step of cutting after annealing, a crystallization step of crystallizing a glass by a heat treatment, a polishing step and then a processing step such as bending and chemical strengthening. In the crystallization step, when defects such as chipping and optical inhomogeneity due to the heat treatment occur, the materials are less likely to flow to the next step, which leads to a loss of the materials and a decrease in yield.

### CITATION LIST

### Patent Literature

Patent Literature 1: WO 2019/022035

### SUMMARY OF INVENTION

### Technical Problem

By performing the forming step, the cutting step, and the crystallization step again after the melting step of remelting the glass ceramics containing the defects, it is possible to prevent a decrease in yield due to the occurrence of the defects in the glass in the crystallization step. However, when the glass ceramics containing the defects are remelted, if the crystals remain, the remaining crystals become nuclei and cause devitrification, and thus the yield further decreases. In addition, depending on a composition of the glass, there is also a problem that other crystals cause devitrification in the glass during remelting.

Accordingly, an object of the present invention is to provide a glass in which crystals in the glass are likely to disappear during remelting and devitrification is less likely to occur.

### Solution to Problem

The present inventors have conducted studies focusing on a residual glass composition of glass ceramics, and as a result, have found that the above problem can be solved by setting the residual glass composition within a specific range, and have made the present invention.

The present invention relates to a glass ceramic having a lithium aluminosilicate composition and including a crystal and a residual glass,

in which the residual glass has a composition including, in terms of mol % based on oxides:

25% to 70% of SiO₂;

3% to 35% of Al₂O₃;

0.1% to 20% of Li₂O;

0.1% to 20% of Na₂O;

0% to 10% of K₂O; and

1% to 15% of ZrO₂, and

a parameter V is −600 or more and 720 or less, the parameter V being calculated based on the following formula by using contents [SiO₂], [Al₂O₃], [P₂O₅], [MgO], [CaO], [SrO], [Li₂O], [Na₂O], [K₂O], [TiO₂], and [ZrO₂] of respective components of SiO₂, Al₂O₃, P₂O₅, MgO, CaO, SrO, Li₂O, Na₂O, K₂O, TiO₂, and ZrO₂ in terms of mol % based on oxides in the residual glass:

V=49.589×[SiO₂]+61.806×[Al₂O₃]+45.456×[P₂O₅]+41.151×[MgO]+110.26×[CaO]+50.263×[SrO]+55.693×[Li₂O]+3.598×[Na₂O]+9.503×[K₂O]+6.83×[TiO₂]−2.885×[ZrO₂]−3746.99.

The present invention relates to a glass ceramic having a lithium aluminosilicate composition and including a crystal and a residual glass,

in which the residual glass has a composition including, in terms of mol % based on oxides:

25% to 70% of SiO₂;

3% to 35% of Al₂O₃;

0.1% to 20% of Li₂O;

0.1% to 20% of Na₂O;

0% to 10% of K₂O; and

1% to 15% of ZrO₂, and

a value is 0.07 or more and 0.5 or less, the value being calculated based on an expression [Al₂O₃]/([SiO₂]+[Al₂O₃]) by using contents [SiO₂] and [Al₂O₃] of respective components of SiO₂ and Al₂O₃ in terms of mol % based on oxides in the residual glass.

The present invention relates to a glass ceramic having a lithium aluminosilicate composition and including a crystal and a residual glass,

in which the residual glass has a composition including, in terms of mol % based on oxides:

25% to 70% of SiO₂;

3% to 35% of Al₂O₃;

0.1% to 20% of Li₂O;

0.1% to 20% of Na₂O;

0% to 10% of K₂O; and

1% to 15% of ZrO₂, and

a value is 0.05 or more and 0.42 or less, the value being calculated based on an expression [ΣR+]/([SiO₂]+[Al₂O₃]) by using a total content [ΣR+] of alkali components and contents [SiO₂] and [Al₂O₃] of respective components of SiO₂ and Al₂O₃ in terms of mol % based on oxides in the residual glass.

The present invention relates to a glass ceramic having a lithium aluminosilicate composition and including a crystal and a residual glass,

in which the residual glass has a composition including, in terms of mol % based on oxides:

25% to 70% of SiO₂;

3% to 35% of Al₂O₃;

0.1% to 20% of Li₂O;

0.1% to 20% of Na₂O;

0% to 10% of K₂O; and

1% to 15% of ZrO₂, and

a parameter G is −13000 or more and less than 1000, the parameter G being calculated based on the following formula by using contents [SiO₂], [Al₂O₃], [MgO], [Li₂O], [Na₂O], [K₂O], and [ZrO₂] of respective components of SiO₂, Al₂O₃, MgO, Li₂O, Na₂O, K₂O, and ZrO₂ in terms of mol % based on oxides in the residual glass:

G=−600.1×[SiO₂]−368.987×[Al₂O₃]−659.214×[MgO]−361.434×[Li₂O]−1184.84×[Na₂O]−1524.6×[K₂O]−1516.47×[ZrO₂]+60922.7.

The present invention relates to a glass ceramic having a lithium aluminosilicate composition and including a crystal and a residual glass,

in which the residual glass has a composition including, in terms of mol % based on oxides:

25% to 70% of SiO₂;

3% to 35% of Al₂O₃;

0.1% to 20% of Li₂O;

0.1% to 20% of Na₂O;

0% to 10% of K₂O; and

1% to 15% of ZrO₂, and

a parameter D is 1400 or more and 2500 or less, the parameter D being calculated based on the following formula by using contents [SiO₂], [Al₂O₃], [MgO], [P₂O₅], [CaO], [Li₂O], [Na₂O], [K₂O], [TiO₂], and [ZrO₂] of respective components of SiO₂, Al₂O₃, MgO, P₂O₅, CaO, Li₂O, Na₂O, K₂O, TiO₂, and ZrO₂ in terms of mol % based on oxides in the composition of the residual glass:

D=−72.3739×[SiO₂]−24.174×[Al₂O₃]−78.0127×[P₂O₅]−80.0648×[MgO]−156.732×[CaO]−61.4172×[Li₂O]−99.7426×[Na₂O]−106.162×[K₂O]−199.391×[TiO₂]+7.09771×[ZrO₂]+7907.11.

The present invention relates to a glass ceramic having a lithium aluminosilicate composition and including a crystal and a residual glass,

in which the residual glass has a composition including, in terms of mol % based on oxides:

25% to 70% of SiO₂;

3% to 35% of Al₂O₃;

0.1% to 20% of Li₂O;

0.1% to 20% of Na₂O;

0% to 10% of K₂O; and

1% to 15% of ZrO₂, and

a sum (V+G) of a parameter V and a parameter G is −12000 or more and 2000 or less, the parameter V and the parameter G being calculated based on the following formulae by using contents [SiO₂], [Al₂O₃], [P₂O₅], [MgO], [CaO], [SrO], [Li₂O], [Na₂O], [K₂O], [TiO₂], and [ZrO₂] of respective components of SiO₂, Al₂O₃, P₂O₅, MgO, CaO, SrO, Li₂O, Na₂O, K₂O, TiO₂, and ZrO₂ in terms of mol % based on oxides in the composition of the residual glass:

V=49.589×[SiO₂]+61.806×[Al₂O₃]+45.456×[P₂O₅]+41.151×[MgO]+110.26×[CaO]+50.263×[SrO]+55.693×[Li₂O]+3.598×[Na₂O]+9.503×[K₂O]+6.83×[TiO₂]−2.885×[ZrO₂]−3746.99;

G=−600.1×[SiO₂]−368.987×[Al₂O₃]−659.214×[MgO]−361.434×[Li₂O]−1184.84×[Na₂O]−1524.6×[K₂O]−1516.47×[ZrO₂]+60922.7.

The present invention relates to a glass ceramic having a lithium aluminosilicate composition and including a crystal and a residual glass,

in which the residual glass has a composition including, in terms of mol % based on oxides:

25% to 70% of SiO₂;

3% to 35% of Al₂O₃;

0.1% to 20% of Li₂O;

0.1% to 20% of Na₂O;

0% to 10% of K₂O; and

1% to 15% of ZrO₂, and

a sum (V+D+G) of a parameter V, a parameter D, and a parameter G is −9000 or more and 3000 or less, the parameter V, the parameter D, and the parameter G being calculated based on the following formulae by using contents [SiO₂], [Al₂O₃], [P₂O₅], [MgO], [CaO], [SrO], [Li₂O], [Na₂O], [K₂O], [TiO₂], and [ZrO₂] of respective components of SiO₂, Al₂O₃, P₂O₅, MgO, CaO, SrO, Li₂O, Na₂O, K₂O, TiO₂, and ZrO₂ in terms of mol % based on oxides in the composition of the residual glass:

V=49.589×[SiO₂]+61.806×[Al₂O₃]+45.456×[P₂O₅]+41.151×[MgO]+110.26×[CaO]+50.263×[SrO]+55.693×[Li₂O]+3.598×[Na₂O]+9.503×[K₂O]+6.83×[TiO₂]−2.885×[ZrO₂]−3746.99;

D=−72.3739×[SiO₂]−24.174×[Al₂O₃]−78.0127×[P₂O₅]−80.0648×[MgO]−156.732×[CaO]−61.4172×[Li₂O]−99.7426×[Na₂O]−106.162×[K₂O]−199.391×[TiO₂]+7.09771×[ZrO₂]+7907.11;

G=−600.1×[SiO₂]−368.987×[Al₂O₃]−659.214×[MgO]−361.434×[Li₂O]−1184.84×[Na₂O]−1524.6×[K₂O]−1516.47×[ZrO₂]+60922.7.

### Advantageous Effects of Invention

In the glass ceramics of the present invention, when a residual glass composition is within a specific range, crystals in the glass are likely to disappear during remelting, and devitrification is less likely to occur. Accordingly, a loss of materials in the production of glass ceramics can be reduced, a yield can be increased, and production efficiency can be improved.

### DESCRIPTION OF EMBODIMENTS

In the present specification, the expression “to” indicating a numerical range is used to include the numerical values described therebefore and thereafter as the lower limit value and the upper limit value, and hereinafter, the expression “to” in the present specification is used with the same meaning unless otherwise specified.

In the present specification, an “amorphous glass” and “glass ceramics” are collectively referred to as a “glass”. In the present specification, the “amorphous glass” refers to a glass in which a diffraction peak showing crystals is not observed by a powder X-ray diffraction method. “Glass ceramic” refer to a material obtained by heat-treating an “amorphous glass” to precipitate crystals, and contains crystals.

The glass ceramic includes a crystal phase and a “residual glass”. The “residual glass” is an amorphous portion in the glass ceramic. A composition of the residual glass can be calculated by estimating a crystallization rate by the Rietveld method and removing the amount of crystals from charged compositions of glass raw materials. The crystallization rate can be calculated from an X-ray diffraction intensity by the Rietveld method. The Rietveld method is described in “Crystal Analysis Handbook” edited by Editing Committee of the Crystallographic Society of Japan (Kyoritsu Shuppan, 1999, pp. 492-499).

In the powder X-ray diffraction measurement, a range of 20 of 10° to 80° is measured using CuKα ray, and when a diffraction peak appears, precipitated crystals are identified by, for example, Hanawalt method.

In the present specification, the term “devitrification” refers to the precipitation of crystals during melting and forming of the glass. The precipitation of crystals during melting and forming of the glass reduces transparency of the glass.

Hereinafter, the term “chemically strengthened glass” refers to a glass after being subjected to a chemical strengthening treatment, and the term “glass for chemical strengthening” refers to a glass before being subjected to a chemical strengthening treatment.

In the present specification, the glass composition is expressed in terms of mol % based on oxides unless otherwise specified, and mol % is simply expressed as “%”.

In addition, in the present specification, “not substantially contained” means that an amount of a component is equal to or lower than a level of an impurity contained in a raw material or the like, that is, the component is not intentionally added. In the present specification, when it is described that a certain component is not substantially contained, a content of the component is specifically, for example, less than 0.1%.

In the present specification, the term “stress profile” represents a compressive stress value with a depth from a glass surface as a variable. In the stress profile, a tensile stress is expressed as a negative compressive stress.

<Glass Ceramics>

The present glass ceramics are preferably lithium aluminosilicate glass ceramics, that is, glass ceramics containing SiO₂, Al₂O₃, and Li₂O as main components. The lithium aluminosilicate glass ceramics obtain high strength by chemically strengthening by an ion exchange treatment.

A composition of the present glass ceramics preferably has a lithium aluminosilicate composition and has the following compositions in terms of mol % based on oxides.

SiO₂ in an amount of 55% to 80%,

Al₂O₃ in an amount of 3% to 20%,

Li₂O in an amount of 1% to 25%,

Na₂O in an amount of 0.1% to 10%,

K₂O in an amount of 0% to 3%, and

ZrO₂ in an amount of 0.1% to 5%

Hereinafter, a preferable composition will be described.

SiO₂ is a component constituting a network of a glass. In addition, SiO₂ is a component that increases chemical durability. A content of SiO₂ is preferably 55% or more, more preferably 57% or more, and still more preferably 60% or more. In order to increase meltability of the glass, the content of SiO₂ is preferably 80% or less, more preferably 77% or less, and still more preferably 75% or less.

Al₂O₃ is an effective component for improving ion exchangeability during chemical strengthening and increasing a surface compressive stress after strengthening. A content of Al₂O₃ is preferably 3% or more, more preferably 4% or more, and still more preferably 5% or more. In order to increase meltability, the content of Al₂O₃ is preferably 20% or less, more preferably 18% or less, and still more preferably 17% or less.

Li₂O is a component for forming a surface compressive stress by ion exchange, and is an essential component of a lithium aluminosilicate glass. In order to increase a depth of a compressive stress layer DOL after chemical strengthening, a content of Li₂O is preferably 1% or more, more preferably 3% or more, and still more preferably 5% or more. In addition, in order to prevent occurrence of devitrification in production of a glass, the content of Li₂O is preferably 25% or less, more preferably 24% or less, and still more preferably 23% or less.

Na₂O is a component for forming a surface compressive stress layer by ion exchange using a molten salt containing potassium, and is a component for improving the meltability of the glass. A content of Na₂O is preferably 0.1% or more, more preferably 0.5% or more, and still more preferably 1.0% or more. In order to maintain chemical durability, the content of Na₂O is preferably 10% or less, more preferably 8% or less, and still more preferably 6% or less.

K₂O is a component for improving meltability of a glass, and is a component for promoting ion exchange. K₂O is an optional component, and in a case where K₂O is contained, a content of K₂O is preferably 0.5% or more, and more preferably 1% or more. In order to maintain the chemical durability, the content of K₂O is preferably 3% or less, more preferably 2% or less, and still more preferably 1% or less.

MgO, CaO, SrO, and BaO are all components for increasing meltability of a glass, but tend to lower an ion exchange performance. MgO, CaO, SrO, and BaO are optional components, and a total content (MgO+CaO+SrO+BaO) in a case where at least one of these is contained is preferably 0.1% or more, and more preferably 0.5% or more.

In a case where MgO is contained, a content of MgO is preferably 0.1% or more, and more preferably 0.5% or more. In order to improve the ion exchange performance, the content of MgO is preferably 10% or less, and more preferably 8% or less.

In a case where CaO is contained, a content of CaO is preferably 0.5% or more, and more preferably 1% or more. In order to improve the ion exchange performance, the content of CaO is preferably 5% or less, and more preferably 3% or less.

In a case where SrO is contained, a content of SrO is preferably 0.5% or more, and more preferably 1% or more. In order to improve the ion exchange performance, the content of SrO is preferably 5% or less, and more preferably 3% or less.

In a case where BaO is contained, a content of BaO is preferably 0.5% or more, and more preferably 1% or more. In order to improve the ion exchange performance, the content of BaO is preferably 5% or less, more preferably 1% or less, and it is still more preferable that BaO is not substantially contained.

ZnO is a component for improving meltability of a glass, and may be contained. In a case where ZnO is contained, a content of ZnO is preferably 0.2% or more, and more preferably 0.5% or more. In order to increase weather resistance of the glass, the content of ZnO is preferably 5% or less, and more preferably 3% or less.

TiO₂ is a component for increasing a surface compressive stress due to ion exchange, and may be contained. In a case where TiO₂ is contained, a content of TiO₂ is preferably 0.1% or more. In order to prevent devitrification during melting, the content of TiO₂ is preferably 5% or less, more preferably 1% or less, and it is still more preferable that TiO₂ is not substantially contained.

ZrO₂ is a component for increasing a surface compressive stress due to ion exchange. A content of ZrO₂ is preferably 0.5% or more, and more preferably 1% or more. In order to prevent devitrification during melting, the content of ZrO₂ is preferably 5% or less, and more preferably 3% or less.

In a case where the glass is colored, coloring components may be added within a range that does not inhibit the achievement of desired chemical strengthening properties. Examples of the coloring components include Co₃O₄, MnO₂, Fe₂O₃, NiO, CuO, Cr₂O₃, V₂O₅, Bi₂O₃, SeO₂, CeO₂, Er₂O₃, Nd₂O₃, and the like. These components may be used alone or in combination.

A total content of the coloring components is preferably 7% or less. Accordingly, devitrification of the glass can be prevented. The content of the coloring component is more preferably 5% or less, still more preferably 3% or less, and particularly preferably 1% or less. In a case where it is desired to increase the visible light transmittance of the glass, it is preferable that these components are not substantially contained.

In addition, SO₃, a chloride, a fluoride, or the like may be appropriately contained as a refining agent during melting of the glass. It is preferable that As₂O₃ is not substantially contained. In a case where Sb₂O₃ is contained, a content of Sb₂O₃ is preferably 0.3% or less, more preferably 0.1% or less, and it is most preferable that Sb₂O₃ is not substantially contained.

<<Residual Glass>>

The residual glass contained in the present glass ceramics preferably has the following composition in terms of mol % based on oxides.

SiO₂ in an amount of 25% to 70%,

Al₂O₃ in an amount of 3% to 35%,

Li₂O in an amount of 0.1% to 20%,

Na₂O in an amount of 0.1% to 20%,

K₂O in an amount of 0% to 10%, and

ZrO₂ in an amount of 1% to 15%.

Hereinafter, a preferable composition of the residual glass will be described.

SiO₂ is an essential component of the lithium aluminosilicate glass ceramics and is also included in the residual glass. A content of SiO₂ in the residual glass is preferably 25% or more because the weather resistance of the residual glass is improved and the weather resistance of the glass ceramics is also improved. The content is more preferably 27.5% or more, and still more preferably 30% or more. In addition, in order to reduce a viscosity of the residual glass and facilitate remelting of the glass ceramics, the content is preferably 70% or less. The content is more preferably 67.5% or less, and still more preferably 65% or less.

Al₂O₃ is an essential component of the lithium aluminosilicate glass ceramics and is also included in the residual glass. When a content of Al₂O₃ in the residual glass is 3% or more, not only the chemical durability of the residual glass is improved, but also chemical strengthening can be performed. The content is more preferably 3.5%, and still more preferably 4.0% or more. In addition, in order to reduce a viscosity of a residual glass composition and facilitate remelting of the glass ceramics, the content is preferably 35% or less. The content is more preferably 32.5% or less, and still more preferably 30% or less.

P₂O₅ is a component that not only functions as a nucleation material for lithium aluminosilicate glass ceramics but also improves chemical strengthening ability, and is an optional component. P₂O₅ in the residual glass is preferably 0.1% or more, more preferably 1% or more, still more preferably 2% or more, and yet still more preferably 3% or more. In addition, from the viewpoint of chemical durability of a residual glass phase of the glass ceramics, a content of P₂O₅ contained in the residual glass is preferably 20% or less. The content is more preferably 18% or less, still more preferably 16% or less, and yet still more preferably 15% or less.

B₂O₃ is a component for reducing a viscosity of the residual glass phase and improving the crystal solubility during remelting, and is an optional component. In addition, from the viewpoint of chemical durability of the residual glass and from the viewpoint of preventing composition variation due to volatilization of B₂O₃ during remelting of the glass ceramics, the content thereof is preferably 10% or less. The content is more preferably 8% or less, still more preferably 6% or less, and yet still more preferably 5% or less. When B₂O₃ is contained in the residual glass, a lower limit of the content thereof is not particularly limited, but is preferably 1% or more, and more preferably 2% or more.

Li₂O is an essential component of the lithium aluminosilicate glass ceramics and is also included in the residual glass. When a content of Li₂O in the residual glass is 0.1% or more, the viscosity of the residual glass during remelting of the glass ceramics is lowered, and the remelting of crystals becomes easy. In addition, a Young's modulus of the residual glass phase can be improved. The content is more preferably 0.15% or more, and still more preferably 0.2% or more. In addition, from the viewpoint of chemical durability of the residual glass phase and prevention of reprecipitation of crystals during remelting of the glass ceramics, the content is preferably 20% or less. The content is more preferably 17.5% or less, and still more preferably 15% or less.

Na₂O can reduce the viscosity of the residual glass of the glass ceramics during remelting, and thus is an essential component. When a content of Na₂O in the residual glass is 0.1% or more, the effect thereof is obtained. The content is more preferably 0.2% or more, still more preferably 0.3% or more, and yet still more preferably 0.5% or more. From the viewpoint of chemical durability of the residual glass, Na₂O in the residual glass is preferably 20% or less. The content is more preferably 17.5% or less, and still more preferably 15% or less.

K₂O is a component capable of reducing the viscosity of the residual glass of the glass ceramics during remelting, and is an optional component. A content of K₂O is preferably 10% or less from the viewpoint of chemical durability of the residual glass. The content is more preferably 7.5% or less, and still more preferably 5% or less. When K₂O is contained in the residual glass, a lower limit of the content thereof is not particularly limited, but is preferably 0.5% or more, and more preferably 1% or more.

ZrO₂ is a component that not only improves mechanical properties of the residual glass but also significantly improves the chemical durability, and thus is an essential component. A content of ZrO₂ in the residual glass is preferably 1% or more, more preferably 2% or more, and still more preferably 3% or more. In addition, in order to prevent reprecipitation of crystals during remelting of the glass ceramics, the content of ZrO₂ in the residual glass is preferably 15% or less. The content is more preferably 14% or less, and still more preferably 13.5% or less.

MgO, CaO, SrO, and BaO are all components for increasing meltability of the glass and are optional components. In a case where MgO is contained in the residual glass, the content thereof is preferably 0.5% or more, and more preferably 1% or more. In addition, in order to prevent reprecipitation of crystals during remelting, a content of MgO in the residual glass is preferably 10% or less, and more preferably 7% or less.

In a case where CaO is contained in the residual glass, the content thereof is preferably 0.5% or more, and more preferably 1% or more. In addition, in order to prevent reprecipitation of crystals during remelting, a content of CaO in the residual glass is preferably 10% or less, and more preferably 7% or less.

In a case where SrO is contained in the residual glass, the content thereof is preferably 0.5% or more, and more preferably 1% or more. In addition, in order to prevent reprecipitation of crystals during remelting, a content of SrO in the residual glass is preferably 10% or less, and more preferably 7% or less.

In a case where BaO is contained in the residual glass, the content thereof is preferably 0.5% or more, and more preferably 1% or more. In addition, in order to prevent reprecipitation of crystals during remelting, a content of BaO in the residual glass is preferably 10% or less, and more preferably 7% or less.

From the viewpoint of the strength characteristics of the glass, a content of TiO₂ in the residual glass is preferably 0% or more, more preferably 0.1% or more, and still more preferably 1% or more. In order to prevent coloring of the glass, the content of TiO₂ in the residual glass is preferably 7% or less, and more preferably 5% or less.

From the viewpoint of improving chemical strengthening properties, in the residual glass of the present glass ceramics, a value calculated based on an expression [Al₂O₃]/([SiO₂]+[Al₂O₃]) is preferably 0.07 or more by using contents [SiO₂] and [Al₂O₃] of respective components of SiO₂ and Al₂O₃ in terms of mol % based on oxides. The value is more preferably 0.10 or more. In addition, since the remelting of crystals becomes difficult due to an increase in viscosity during the remelting of the glass ceramics, [Al₂O₃]/([SiO₂]+[Al₂O₃]) is preferably 0.5 or less. [Al₂O₃]/([SiO₂]+[Al₂O₃]) is more preferably 0.49 or less, and still more preferably 0.47 or less.

In order to improve the meltability of the crystals during remelting of the present glass ceramics and to improve the chemical strengthening properties, a value calculated based on an expression [ΣR+]/([SiO₂]+[Al₂O₃]) by using a total content ΣR+ of alkali components and contents of respective components of SiO₂ and Al₂O₃ in terms of mol % based on oxides in the residual glass is preferably 0.05 or more. The value is more preferably 0.07 or more, and still more preferably 0.1 or more. In addition, from the viewpoint of the chemical durability of the residual glass phase of the glass ceramics, [ΣR+]/([SiO₂]+[Al₂O₃]) is preferably 0.45 or less. The value is more preferably 0.42 or less, still more preferably 0.40 or less, and yet still more preferably 0.38 or less.

In the residual glass composition of the present glass ceramics, a parameter V is −600 or more and 720 or less, the parameter V being calculated based on the following formula by using contents [SiO₂], [Al₂O₃], [P₂O₅], [MgO], [CaO], [SrO], [Li₂O], [Na₂O], [K₂O], [TiO₂], and [ZrO₂] of respective components of SiO₂, Al₂O₃, P₂O₅, MgO, CaO, SrO, Li₂O, Na₂O, K₂O, TiO₂, and ZrO₂.

V=49.589×[SiO₂]+61.806×[Al₂O₃]+45.456×[P₂O₅]+41.151×[MgO]+110.26×[CaO]+50.263×[SrO]+55.693×[Li₂O]+3.598×[Na₂O]+9.503×[K₂O]+6.83×[TiO₂]−2.885×[ZrO₂]−3746.99

According to the studies of the present inventors, the parameter V is a parameter that represents the ease of melting of a LAS-based crystal phase during remelting of the glass ceramics. When the defects are found in a glass ceramic article, a material loss may be reduced by remelting the article. At this time, as the crystals are easily melted during remelting of the glass ceramics, the remelting is more easily performed, and the production efficiency can be increased.

The parameter V is preferably −600 or more because transparent LAS-based glass ceramics can be easily obtained. The parameter V is more preferably −500 or less, still more preferably −400 or less, and yet still more preferably −300 or less.

The parameter V is preferably 720 or less because the crystals are easily remelted. The parameter V is more preferably 700 or less, and still more preferably 680 or less.

A parameter G is preferably −13000 or more and less than 1000, the parameter G being calculated based on the following formula by using contents [SiO₂], [Al₂O₃], [MgO], [Li₂O], [K₂O], and [ZrO₂] of respective components of SiO₂, Al₂O₃, MgO, Li₂O, K₂O, and ZrO₂ in terms of mol % based on oxides in the residual glass composition of the present glass ceramics.

G=−600.1×[SiO₂]−368.987×[Al₂O₃]−659.214×[MgO]−361.434×[Li₂O]−1184.84×[Na₂O]−1524.6×[K₂O]−1516.47×[ZrO₂]+60922.7

According to the studies of the present inventors, the parameter G represents the ease of reprecipitation of LAS-based crystals during remelting of the glass ceramics.

When the parameter G is −13000 or more, a residual glass phase exhibiting high strength can be designed while preventing precipitation of the LAS-based crystals. The parameter G is more preferably −12000 or more, and still more preferably −11000 or more.

From the viewpoint of production properties, the parameter G is preferably less than 1000 as devitrification due to reprecipitation of the LAS-based crystals can be prevented. The parameter G is more preferably less than 500, and still more preferably less than 0.

A parameter D is preferably 1400 or more and 2500 or less, the parameter D being calculated based on the following formula by using contents [SiO₂], [Al₂O₃], [MgO], [P₂O₅], [CaO], [Li₂O], [Na₂O], [K₂O], [TiO₂], and [ZrO₂] of respective components of SiO₂, Al₂O₃, MgO, P₂O₅, CaO, Li₂O, Na₂O, K₂O, TiO₂, and ZrO₂ in terms of mol % based on oxides in the composition of the residual glass.

D=−72.3739×[SiO₂]−24.174×[Al₂O₃]−78.0127×[P₂O₅]−80.0648×[MgO]−156.732×[CaO]−61.4172×[Li₂O]−99.7426×[Na₂O]−106.162×[K₂O]−199.391×[TiO₂]+7.09771×[ZrO₂]+7907.11

According to the studies of the present inventors, the parameter D represents the ease of formation of Zr-based crystals during remelting of the glass ceramics.

The parameter D is preferably 1400 or more because a residual glass having high strength can be designed while devitrification due to precipitation of the Zr-based crystals is prevented. The parameter D is more preferably 1450 or more, and still more preferably 1500 or more.

The parameter D is preferably 2500 or less, as Zr-based defects that occur during remelting of the glass ceramics can be prevented. The parameter D is more preferably 2400 or less, and still more preferably 2300 or less.

A sum (V+G) of the parameter V and the parameter G is preferably 2000 or less.

When the sum (V+G) of the parameter V and the parameter G is 2000 or less, the reprecipitation of the LAS-based crystals generated when the glass ceramics are returned to the process again can be prevented, and the transparent glass ceramics can be obtained again. The sum (V+G) of the parameter V and the parameter G is preferably 1500 or less, and more preferably 1000 or less.

When the sum (V+G) of the parameter V and the parameter G is preferably −12000 or more, a residual glass composition having high strength can be designed. The sum (V+G) of the parameter V and the parameter G is more preferably −11000 or more, and still more preferably −10500 or more.

A sum (V+D+G) of the parameter V, the parameter D, and the parameter G is preferably 3000 or less.

The sum (V+D+G) of the parameter V, the parameter D, and the parameter G is preferably 3000 or less from the viewpoint of preventing the LAS-based crystals and the Zr-based crystals generated when the glass ceramics are remelted. (V+D+G) is more preferably 2750 or less, and still more preferably 2500 or less. In addition, (V+D+G) is preferably −9000 or more, more preferably −8500 or more, and still more preferably −8000 or more from the viewpoint of designing a residual glass composition of transparent LAS-based glass ceramics having high strength.

<Crystal>

The present glass ceramics preferably have a crystallization rate of 50% to 90%, more preferably 53% to 87%, still more preferably 55% to 85%, and yet still more preferably 60% to 80%, from the viewpoint of improving mechanical properties.

Crystals contained in the present glass ceramics are preferably crystals (LAS-based crystals) containing SiO₂, Al₂O₃, and Li₂O. This is because, when the LAS-based crystals are contained, very high strength can be obtained by the chemical strengthening treatment.

The present glass ceramics more preferably contains at least one LAS-based crystal selected from a β-spodumene crystal, a petalite crystal, and a eucryptite crystal.

A proportion of the LAS-based crystals in the crystals contained in the present glass ceramics is preferably 30% to 70% by mass. When the content of the LAS-based crystals is 30% by mass or more, the strength can be sufficiently improved by the chemical strengthening treatment. When the LAS-based crystals are 70% by mass or less, transparency can be improved. This is probably because a particle diameter of a crystal is reduced by generation of crystals having different compositions. The proportion of the LAS-based crystals contained in the glass ceramics can be calculated by identifying precipitated crystals by powder X-ray diffraction and estimating an amount of crystallization by the Rietveld method from the obtained diffraction intensity.

For example, β-spodumene is precipitated in glass ceramics shown in Examples 1, 2, and 9 described later in Example. A stoichiometric composition of the β-spodumene is represented as LiAlSi₂O₆, and is generally a crystal showing diffraction peaks at Bragg angles (2θ) of 25.55°±0.05°, 22.71°±0.05°, and 28.20°±0.05° in an X-ray diffraction pattern. However, the obtained X-ray diffraction pattern is slightly shifted to a high angle side, and by using the Rietveld method, the precipitation of β-spodumene crystals containing defects can be confirmed. Specifically, Li_{0.4}□_{0.6}AlSi₂O₆ is used, and □ means the amount of defects.

Examples of crystals other than the LAS-based crystals include lithium metasilicate, lithium disilicate, and lithium phosphate. By containing crystals other than the LAS-based crystals, the transparency of the glass ceramics can be improved.

<Method for Producing Glass Ceramic and Chemically Strengthened Glass>

A chemically strengthened glass can be produced by subjecting the present glass ceramic to a chemical strengthening treatment. The glass ceramic is produced by a method of crystallizing an amorphous glass by a heat treatment.

(Production of Amorphous Glass)

The amorphous glass can be produced, for example, by the following method. The production method described below is an example in which a sheet-shaped chemically strengthened glass is produced.

Glass raw materials are blended so as to obtain a glass having a preferable composition, and the glass raw materials are heated and melted in a glass melting furnace. Thereafter, the molten glass is homogenized by bubbling, stirring, addition of a refining agent, or the like, formed into a glass sheet having a predetermined thickness by a known forming method, and annealed. Alternatively, the molten glass may be formed into a sheet shape by a method of forming the molten glass into a block shape, annealing and then cutting the glass block.

(Crystallization Treatment)

Glass ceramics are obtained by subjecting the amorphous glass obtained by the above procedure to a heat treatment.

The heat treatment may be performed in two stages in which the temperature is increased from room temperature to a first treatment temperature, and the amorphous glass is held for a certain period of time, and then the amorphous glass is held for a certain period of time at a second treatment temperature that is higher than the first treatment temperature. Alternatively, the heat treatment may be performed in one stage in which the amorphous glass is held at a specific treatment temperature and then cooled to room temperature.

In the case of the two-stage heat treatment, the first treatment temperature is preferably a temperature range in which a crystal nucleation rate increases in the glass composition, and the second treatment temperature is preferably a temperature range in which the crystal growth rate increases in the glass composition. A holding time at the first treatment temperature is preferably kept long so that a sufficient number of crystal nuclei are generated. When a large number of crystal nuclei are formed, the size of each crystal is reduced, and glass ceramics having high transparency are obtained.

In the case of the two-stage treatment, for example, the glass is held at the first treatment temperature of 500° C. to 700° C. for 1 hour to 6 hours, and then, the glass is held at the second treatment temperature of 600° C. to 800° C. for 1 hour to 6 hours. In the case of the one-stage treatment, for example, the glass is held at 500° C. to 800° C. for 1 hour to 6 hours.

The glass ceramics obtained by the above procedure are subjected to a grinding and polishing treatment as necessary to form a glass ceramic sheet. If the glass ceramic sheet is cut into a predetermined shape and size or subjected to chamfering, it is preferable the glass ceramic sheet is cut or subjected to chamfering before the chemical strengthening treatment is performed, because a compressive stress layer is also formed on an end surface by a subsequent chemical strengthening treatment.

(Chemical Strengthening Treatment)

The chemical strengthening treatment is a treatment in which, by a method of immersing a glass into a melt of a metal salt (for example, potassium nitrate) containing metal ions (typically, Na ions or K ions) having a large ionic radius, the glass is brought into contact with the metal salt, and thus metal ions having a small ionic radius (typically, Na ions or Li ions) in the glass are substituted with the metal ions having a large ionic radius (typically, Na ions or K ions for Li ions, and K ions for Na ions).

In order to increase a rate of the chemical strengthening treatment, it is preferable to use “Li—Na exchange” in which Li ions in the glass are exchanged with Na ions. In addition, in order to form a large compressive stress by ion exchange, it is preferable to use “Na—K exchange” in which Na ions in the glass are exchanged with K ions.

Examples of the molten salt for performing the chemical strengthening treatment include a nitrate, a sulfate, a carbonate, and a chloride. Examples of the nitrate include lithium nitrate, sodium nitrate, potassium nitrate, cesium nitrate, and silver nitrate. Examples of the sulfate include lithium sulfate, sodium sulfate, potassium sulfate, cesium sulfate, and silver sulfate. Examples of the carbonate include lithium carbonate, sodium carbonate, and potassium carbonate. Examples of the chloride include lithium chloride, sodium chloride, potassium chloride, cesium chloride, and silver chloride. One of these molten salts may be used alone, or a plurality thereof may be used in combination.

As treatment conditions of the chemical strengthening treatment, time, temperature, and the like can be selected in consideration of the glass composition, the type of molten salt, and the like. For example, the present glass ceramics are subjected to the chemical strengthening treatment at preferably 450° C. or less for preferably 1 hour or less. Specifically, for example, a treatment is exemplified in which the present glass ceramics are immersed in a molten salt (for example, a mixed salt of lithium nitrate and sodium nitrate) containing preferably 0.3% by mass of Li and 99.7% by mass of Na at 450° C. for preferably about 0.5 hours.

The chemical strengthening treatment may be performed by, for example, two-stage ion exchange as follows. First, the present glass ceramics are preferably immersed in a metal salt (for example, sodium nitrate) containing Na ions at about 350° C. to 500° C. for about 0.1 to 10 hours. Accordingly, ion exchange between Li ions in the glass ceramics and Na ions in the metal salt occurs, and a relatively deep compressive stress layer can be formed.

Next, the present glass ceramics are preferably immersed in a metal salt (for example, potassium nitrate) containing K ions at about 350° C. to 500° C. for about 0.1 to 10 hours. Accordingly, a large compressive stress is generated in a portion of the compressive stress layer formed in the previous treatment, for example, within a depth of about 10 According to such two-stage treatment, a stress profile having a large surface compressive stress value is easily obtained.

The chemically strengthened glass obtained by chemically strengthening the present glass ceramics is also useful as a cover glass used for electronic devices such as mobile devices such as mobile phones and smartphones. Further, the chemically strengthened glass is also useful for a cover glass of an electronic device such as a television, a personal computer, and a touch panel, an elevator wall surface, or a wall surface (full-screen display) of a construction such as a house and a building, which are not intended to be carried. The chemically strengthened glass is also useful as a building material such as a window glass, a table top, an interior of an automobile, an airplane, or the like, and a cover glass thereof, or a casing having a curved surface shape.

### Examples

Hereinafter, the present invention will be described with reference to Examples, but the present invention is not limited thereto.

<Production of Amorphous Glass>

Glass raw materials were blended so as to obtain glass compositions shown in Table 1 in terms of mol % based on oxides, and weighed such that a glass has a weight of 800 g. Next, the mixed glass raw materials were put into a platinum crucible, followed by being put into an electric furnace at 1600° C., and were melted for about 5 hours, defoamed, and homogenized.

The obtained molten glass was poured into a mold, held at a temperature of a glass transition point for 1 hour, and then cooled to a room temperature at a rate of 0.5° C./min to obtain a glass block.

Glass ceramics are obtained by subjecting a glass having a composition shown in Table 1 to a heat treatment. In Table 1, a blank column indicates that a component is not contained.

TABLE 1

| | G1 | G2 | G3 | G4 |
|---|---|---|---|---|
| SiO₂ | 68.70 | 70.43 | 69.55 | 69.66 |
| Al₂O₃ | 11.00 | 6.87 | 5.55 | 14.62 |
| P₂O₅ | 2.00 | 1.02 | 0.70 | 1.41 |
| B₂O₃ | 0.00 | 0.52 | | |
| MgO | | | | |
| CaO | | | | |
| SrO | | | | |
| BaO | | | | 0.43 |
| Li₂O | 14.40 | 18.10 | 22.15 | 9.57 |
| Na₂O | 2.40 | 1.58 | 1.10 | 2.15 |
| K₂O | | 0.25 | 0.10 | 0.92 |
| Fe₂O₃ | | | | |
| TiO₂ | | | | |
| ZrO₂ | 1.50 | 1.24 | 0.85 | 1.24 |
| SnO₂ | 0.50 | | | 0.5 |

<Crystallization Treatment and Evaluation of Glass Ceramics>

For G1 to G4, the obtained glass block was processed into a size of 50 mm×50 mm×1.5 mm, and then heat-treated under the conditions described in Tables 2 and 3 to obtain glass ceramics. In the columns of the crystallization conditions in the tables, the upper row is nucleation treatment conditions and the lower row is crystal growth treatment conditions. For example, when the upper row describes 650° C. for 2 hours and the lower row describes 850° C. for 2 hours, it means that the glass is held at 650° C. for 2 hours and then held at 850° C. for 2 hours. G1 to G8 are Working Examples, and G9 is a Comparative Example.

The obtained glass ceramics were processed and mirror-polished to obtain a glass ceramic sheet having a thickness t of 0.7 mm. A part of the glass ceramics was pulverized, and powder X-ray diffraction was measured under the following conditions to identify precipitated crystals. In addition, a crystallization rate was calculated from the obtained diffraction intensity by the Rietveld method. The results are shown in Tables 2 and 3. Residual glass compositions in terms of mol % based on oxides are shown in the columns of SiO₂ to TiO₂ in Tables 2 and 3.

Measurement device: SmartLab manufactured by Rigaku Corporation

X-ray used: CuKα ray

Measurement range: 2θ=10° to 80°

Speed: 10°/min

Step: 0.02°

TABLE 2

| | Example | Example | Example | Example |
|---|---|---|---|---|
| | 1 | 2 | 3 | 4 |
| | Base Glass | | | |
| | G1 | G1 | G2 | G2 |
| | Heat Treatment Conditions | | | |
| | 650° C. | 650° C. | 580° C. | 575° C. |
| | 2 h | 2 h | 2 h | 1.5 h |
| | 850° C. | 850° C. | 730° C. | 730° C. |
| | 2 h | 2.5 h | 2 h | 2.5 h |
| SiO₂ | 53 | 51.3 | 60.7 | 57.4 |
| Al₂O₃ | 8.1 | 5.9 | 12.8 | 12.6 |
| P₂O₅ | 14.3 | 14.5 | 4.4 | 4.9 |
| B₂O₃ | 0 | 0 | 2.2 | 2.5 |
| Li₂O | 3.8 | 6.3 | 6.8 | 7.7 |
| Na₂O | 10.1 | 10.3 | 6.8 | 7.6 |
| K₂O | 0 | 0 | 1.1 | 1.2 |
| ZrO₂ | 10.7 | 11.2 | 5.3 | 6 |
| MgO | 0 | 0 | 0 | 0 |
| CaO | 0 | 0 | 0 | 0 |
| SrO | 0 | 0 | 0 | 0 |
| BaO | 0 | 0 | 0 | 0 |
| TiO₂ | 0 | 0 | 0 | 0 |
| Al₂O₃/(SiO₂ + | 0.13 | 0.1 | 0.17 | 0.18 |
| Al₂O₃) | | | | |
| ΣR+/(SiO₂ + | 0.23 | 0.29 | 0.2 | 0.24 |
| Al₂O₃) | | | | |
| V | 248 | 196 | 650 | 554 |
| G | −3463 | −3568 | −337 | −923 |
| D | 1597 | 1547 | 1699 | 1743 |
| V + G | −3215 | −3373 | 313 | −369 |
| V + D + G | −1618 | −1825 | 2012 | 1375 |
| Crystals | LiSi₂O₅ | LiSi₂O₅ | LiSi₂O₅ | LiSi₂O₅ |
| | β-spod- | β-spod- | Petalite | Petalite |
| | umene | umene | | |
| Crystallization | 82 | 83 | 72 | 75 |
| Rate (%) | | | | |
| Proportion of | 68 | 70 | 56 | 59 |
| LAS-based | | | | |
| Crystals | | | | |
| (mass %) | | | | |

TABLE 3

| | Example | Example | Example | Example | Example |
|---|---|---|---|---|---|
| | 5 | 6 | 7 | 8 | 9 |
| | Base Glass | | | | |
| | G2 | G3 | G3 | G3 | G4 |
| | Heat Treatment Conditions | | | | |
| | 585° C. | 580° C. | 580° C. | 590° C. | 650° C. |
| | 2 h | 2 h | 1.5 h | 1 h | 1 h |
| | 735° C. | 730° C. | 740° C. | 735° C. | 850° C. |
| | 3.3 h | 2 h | 2 h | 1.5 h | 1.5 h |
| SiO₂ | 38.8 | 50.5 | 30.5 | 58.6 | 56.6 |
| Al₂O₃ | 17.3 | 14.3 | 25.8 | 19.2 | 3.1 |
| P₂O₅ | 9.7 | 5.5 | 10.9 | 5.2 | 5.6 |
| B₂O₃ | 4.9 | 0 | 0 | 0 | 0 |
| BaO | 0 | 0 | 0 | 0 | 1.7 |
| Li₂O | 0.3 | 13.7 | 0.8 | 1.7 | 21.5 |
| Na₂O | 15 | 8.6 | 17.2 | 8.2 | 3 |
| K₂O | 2.3 | 0.8 | 1.6 | 0.8 | 3.7 |
| ZrO₂ | 11.7 | 6.6 | 13.3 | 6.3 | 4.9 |
| MgO | 0 | 0 | 0 | 0 | 0 |
| CaO | 0 | 0 | 0 | 0 | 0 |
| SrO | 0 | 0 | 0 | 0 | 0 |
| BaO | 0 | 0 | 0 | 0 | 1.7 |
| TiO₂ | 0 | 0 | 0 | 0 | 0 |
| Al₂O₃/(SiO₂ + | 0.31 | 0.22 | 0.46 | 0.25 | 0.05 |
| Al₂O₃) | | | | | |
| ΣR+/(SiO₂ + | 0.31 | 0.36 | 0.35 | 0.14 | 0.47 |
| Al₂O₃) | | | | | |
| V | −254 | 674 | −62 | 696 | 729 |
| G | −7904 | −1050 | −10026 | −2406 | 1470 |
| D | 2255 | 1745 | 2390 | 1839 | 1329 |
| V + G | −8158 | −377 | −10088 | −1710 | 2199 |
| V + D + G | −5903 | 1369 | −7698 | 128 | 3527 |
| Crystals | LiSi₂O₅ | LiSi₂O₅ | LiSi₂O₅ | LiSi₂O₅ | β-spod- |
| | Petalite | Petalite | Petalite | Petalite | umene |
| Crystallization | 85 | 84 | 90 | 82 | 78 |
| Rate (%) | | | | | |
| Proportion of | 61 | 48 | 47 | 39 | 100 |
| LAS-based | | | | | |
| Crystals | | | | | |
| (mass %) | | | | | |

As shown in Tables 2 and 3, in Examples 1 to 8 which are Working Examples, values of [Al₂O₃]/([SiO₂]+[Al₂O₃]), [ΣR+]/([SiO₂]+[Al₂O₃]), parameters V, G, and D, (V+D), and (V+D+G) are all within a range specified in the present invention, devitrification is likely to disappear during remelting, and reprecipitation of devitrification is less likely to occur. On the other hand, in Example 9 which is a Comparative Example, these values are out of the range specified in the present invention, devitrification is less likely to disappear during remelting, and devitrification is likely to reprecipitate. Therefore, it can be said that a glass in which the values of [Al₂O₃]/([SiO₂]+[Al₂O₃]), [ΣR+]/([SiO₂]+[Al₂O₃]), parameters V, G, and D, (V+D), and (V+D+G) are within the range specified in the present invention is excellent in recyclability.

Although the present invention has been described in detail with reference to specific examples, it is apparent to those skilled in the art that it is possible to add various alterations and modifications without departing from the spirit and the scope of the present invention.

1. A glass ceramic having a lithium aluminosilicate composition and comprising a crystal and a residual glass,
wherein the residual glass has a composition comprising, in terms of mol % based on oxides:
25% to 70% of SiO₂;
3% to 35% of Al₂O₃;
0.1% to 20% of Li₂O;
0.1% to 20% of Na₂O;
0% to 10% of K₂O; and
1% to 15% of ZrO₂, and
a parameter V is −600 or more and 720 or less, the parameter V being calculated based on the following formula by using contents [SiO₂], [Al₂O₃], [P₂O₅], [MgO], [CaO], [SrO], [Li₂O], [Na₂O], [K₂O], [TiO₂], and [ZrO₂] of respective components of SiO₂, Al₂O₃, P₂O₅, MgO, CaO, SrO, Li₂O, Na₂O, K₂O, TiO₂, and ZrO₂ in terms of mol % based on oxides in the residual glass:
V=49.589×[SiO₂]+61.806×[Al₂O₃]+45.456×[P₂O₅]+41.151×[MgO]+110.26×[CaO]+50.263×[SrO]+55.693×[Li₂O]+3.598×[Na₂O]+9.503×[K₂O]+6.83×[TiO₂]−2.885×[ZrO₂]−3746.99.

2. A glass ceramic having a lithium aluminosilicate composition and comprising a crystal and a residual glass,
wherein the residual glass has a composition comprising, in terms of mol % based on oxides:
25% to 70% of SiO₂;
3% to 35% of Al₂O₃;
0.1% to 20% of Li₂O;
0.1% to 20% of Na₂O;
0% to 10% of K₂O; and
1% to 15% of ZrO₂, and
a value is 0.07 or more and 0.5 or less, the value being calculated based on an expression [Al₂O₃]/([SiO₂]+[Al₂O₃]) by using contents [SiO₂] and [Al₂O₃] of respective components of SiO₂ and Al₂O₃ in terms of mol % based on oxides in the residual glass.

3. A glass ceramic having a lithium aluminosilicate composition and comprising a crystal and a residual glass,
wherein the residual glass has a composition comprising, in terms of mol % based on oxides:
25% to 70% of SiO₂;
3% to 35% of Al₂O₃;
0.1% to 20% of Li₂O;
0.1% to 20% of Na₂O;
0% to 10% of K₂O; and
1% to 15% of ZrO₂, and
a value is 0.05 or more and 0.42 or less, the value being calculated based on an expression [ΣR+]/([SiO₂]+[Al₂O₃]) by using a total content [ΣR+] of alkali components and contents [SiO₂] and [Al₂O₃] of respective components of SiO₂ and Al₂O₃ in terms of mol % based on oxides in the residual glass.

4. A glass ceramic having a lithium aluminosilicate composition and comprising a crystal and a residual glass,
wherein the residual glass has a composition comprising, in terms of mol % based on oxides:
25% to 70% of SiO₂;
3% to 35% of Al₂O₃;
0.1% to 20% of Li₂O;
0.1% to 20% of Na₂O;
0% to 10% of K₂O; and
1% to 15% of ZrO₂, and
a parameter G is −13000 or more and less than 1000, the parameter G being calculated based on the following formula by using contents [SiO₂], [Al₂O₃], [MgO], [Li₂O], [Na₂O], [K₂O], and [ZrO₂] of respective components of SiO₂, Al₂O₃, MgO, Li₂O, Na₂O, K₂O, and ZrO₂ in terms of mol % based on oxides in the residual glass:
G=−600.1×[SiO₂]−368.987×[Al₂O₃]−659.214×[MgO]−361.434×[Li₂O]−1184.84×[Na₂O]−1524.6×[K₂O]−1516.47×[ZrO₂]+60922.7.

5. A glass ceramic having a lithium aluminosilicate composition and comprising a crystal and a residual glass,
wherein the residual glass has a composition comprising, in terms of mol % based on oxides:
25% to 70% of SiO₂;
3% to 35% of Al₂O₃;
0.1% to 20% of Li₂O;
0.1% to 20% of Na₂O;
0% to 10% of K₂O; and
1% to 15% of ZrO₂, and
a parameter D is 1400 or more and 2500 or less, the parameter D being calculated based on the following formula by using contents [SiO₂], [Al₂O₃], [MgO], [P₂O₅], [CaO], [Li₂O], [Na₂O], [K₂O], [TiO₂], and [ZrO₂] of respective components of SiO₂, Al₂O₃, MgO, P₂O₅, CaO, Li₂O, Na₂O, K₂O, TiO₂, and ZrO₂ in terms of mol % based on oxides in the composition of the residual glass:
D=−72.3739×[SiO₂]−24.174×[Al₂O₃]−78.0127×[P₂O₅]−80.0648×[MgO]−156.732×[CaO]−61.4172×[Li₂O]−99.7426×[Na₂O]−106.162×[K₂O]−199.391×[TiO₂]+7.09771×[ZrO₂]+7907.11.

6. A glass ceramic having a lithium aluminosilicate composition and comprising a crystal and a residual glass,
wherein the residual glass has a composition comprising, in terms of mol % based on oxides:
25% to 70% of SiO₂;
3% to 35% of Al₂O₃;
0.1% to 20% of Li₂O;
0.1% to 20% of Na₂O;
0% to 10% of K₂O; and
1% to 15% of ZrO₂, and
a sum (V+G) of a parameter V and a parameter G is −12000 or more and 2000 or less, the parameter V and the parameter G being calculated based on the following formulae by using contents [SiO₂], [Al₂O₃], [P₂O₅], [MgO], [CaO], [SrO], [Li₂O], [Na₂O], [K₂O], [TiO₂], and [ZrO₂] of respective components of SiO₂, Al₂O₃, P₂O₅, MgO, CaO, SrO, Li₂O, Na₂O, K₂O, TiO₂, and ZrO₂ in terms of mol % based on oxides in the composition of the residual glass:
V=49.589×[SiO₂]+61.806×[Al₂O₃]+45.456×[P₂O₅]+41.151×[MgO]+110.26×[CaO]+50.263×[SrO]+55.693×[Li₂O]+3.598×[Na₂O]+9.503×[K₂O]+6.83×[TiO₂]−2.885×[ZrO₂]−3746.99;
G=−600.1×[SiO₂]−368.987×[Al₂O₃]−659.214×[MgO]−361.434×[Li₂O]−1184.84×[Na₂O]−1524.6×[K₂O]−1516.47×[ZrO₂]+60922.7.

7. A glass ceramic having a lithium aluminosilicate composition and comprising a crystal and a residual glass,
wherein the residual glass has a composition comprising, in terms of mol % based on oxides:
25% to 70% of SiO₂;
3% to 35% of Al₂O₃;
0.1% to 20% of Li₂O;
0.1% to 20% of Na₂O;
0% to 10% of K₂O; and
1% to 15% of ZrO₂, and
a sum (V+D+G) of a parameter V, a parameter D, and a parameter G is −9000 or more and 3000 or less, the parameter V, the parameter D, and the parameter G being calculated based on the following formulae by using contents [SiO₂], [Al₂O₃], [P₂O₅], [MgO], [CaO], [SrO], [Li₂O], [Na₂O], [K₂O], [TiO₂], and [ZrO₂] of respective components of SiO₂, Al₂O₃, P₂O₅, MgO, CaO, SrO, Li₂O, Na₂O, K₂O, TiO₂, and ZrO₂ in terms of mol % based on oxides in the composition of the residual glass:
V=49.589×[SiO₂]+61.806×[Al₂O₃]+45.456×[P₂O₅]+41.151×[MgO]+110.26×[CaO]+50.263×[SrO]+55.693×[Li₂O]+3.598×[Na₂O]+9.503×[K₂O]+6.83×[TiO₂]−2.885×[ZrO₂]−3746.99;
D=−72.3739×[SiO₂]−24.174×[Al₂O₃]−78.0127×[P₂O₅]−80.0648×[MgO]−156.732×[CaO]−61.4172×[Li₂O]−99.7426×[Na₂O]−106.162×[K₂O]−199.391×[TiO₂]+7.09771×[ZrO₂]+7907.11;
G=−600.1×[SiO₂]−368.987×[Al₂O₃]−659.214×[MgO]−361.434×[Li₂O]−1184.84×[Na₂O]−1524.6×[K₂O]−1516.47×[ZrO₂]+60922.7.

8. The glass ceramic according to claim 1, further comprising at least one LAS-based crystal selected from a β-spodumene crystal, a petalite crystal, and a eucryptite crystal.

9. The glass ceramic according to claim 1, wherein a crystallization rate is 50% to 90%.

10. The glass ceramic according to claim 1, wherein a proportion of LAS-based crystal in the crystal contained in the glass ceramic is 30% to 70% by mass.
